(19) United States
(12) Patent Application Publication
(10) Pub. No.: US 2023/0385240 A1
(43) Pub. Date: Nov. 30, 2023

(54) OPTIMIZATIONS FOR DATA DEDUPLICATION OPERATIONS

(71) Applicant: MICROSOFT TECHNOLOGY LICENSING, LLC, Redmond, WA (US)

(72) Inventors: Rajsekhar DAS, Sammamish, WA (US); Gregory David GARBERN, Seattle, WA (US)

(21) Appl. No.: 17/829,012

(22) Filed: May 31, 2022

(51) Int. Cl. G06F 16/174

(52) U.S. Cl. CPC G06F 16/1748

(57) ABSTRACT

The techniques disclosed herein enable systems to efficiently perform data deduplication operations through the introduction of stability tags. To achieve this, a stability tag for an associated block of data is set prior to analysis by a data deduplication process. While the stability tag is set, the block of data is understood by the system to be in a known state. An identifier is then generated based on the content within the block of data. At a later time, the deduplication process detects a second block of data that results in a matching identifier, indicating a potential candidate for deduplication. In response, the deduplication process returns to the stability tag of the first block of data and the second block of data. If the stability tags are still set, indicating no modification to the blocks of data, one of the blocks of data is eligible to be scheduled for deduplication.

### BACKGROUND

As the scale and complexity of computing rapidly increases, demand for high-speed and high-capacity storage naturally increases as well. With the advent of solid-state devices (SSDs), modern storage systems often boast much higher speeds in comparison to traditional mechanical devices such as hard-disk drives. Moreover, many organizations invested heavily in protocols and file systems for efficiently managing storage devices, particularly ones deployed in large-scale data storage systems such as datacenters. One technique for ensuring optimal storage utilization is data deduplication. Data deduplication aims to eliminate duplicate copies of repeating data. Consequently, total data size is reduced thereby improving storage utilization.

Typically, data deduplication involves evaluating a volume of data (e.g., the contents of an SSD) to identify repeating blocks of data. In various examples, this is accomplished by reading a first block of data, generating an associated identifier for the first block of data, and storing the identifier for later reference. At a later point, a subsequent block of data may produce the same identifier indicating matching content and that the subsequent block is a redundant block of data. Accordingly, the deduplication process deletes the redundant block of data. In addition, the redundant block of data is replaced with a reference that points to the first block of data. Consequently, the amount of data that must be stored is dramatically decreased depending on the frequency of repeated blocks of data.

In this way, data deduplication reduces the overall amount of hardware storage media required to meet storage capacity needs. While this is beneficial for individual users who may have one or a few storage devices in a personal computer, the benefits of data deduplication are exponentially more impactful in large-scale storage solutions. For example, even a relatively small reduction in required storage capacity (e.g., five percent) can result in millions of dollars of saved costs for a cloud computing organization operating many datacenters around the world. However, data deduplication is oftentimes a computationally intensive task which can negatively impact normal file system operations.

### SUMMARY

The techniques disclosed herein improve the functionality of data storage systems by the introduction of stability tags. The stability tags reduce computing costs associated with data deduplication operations. As described herein, a stability tag for a block of data is set prior to the block of data being read and analyzed by a deduplication module (e.g., a deduplication process). When the stability tag is set, the stability tag indicates the associated block of data is currently in a known state (i.e., a state where the data is known to the deduplication module). The known state may alternatively be referred to as a stable state. Accordingly, the stability tag indicates whether the content of the associated block of data has been modified since it was last read for deduplication purposes. Stated another way, by checking the stability tag, the deduplication module can determine whether a block of data has been modified without having to fully read the content within the block of data. Consequently, the stability tag streamlines deduplication operations thereby improving overall efficiency.

For the sake of clarity, it should be understood that setting and clearing the stability tag relate to the state of the stability tag in the context of the present disclosure. In one example, the stability tag is a single bit, where a set stability tag corresponds to a one, “1”, meaning that the content of the data block has not been modified since the last time the content was read and analyzed, and a cleared stability tag corresponds to a zero, “0”, meaning that the content of the data block has been modified since the last time the content was read and analyzed.

The data deduplication module can be a component and/or an extension of a file system for enabling data deduplication operations. In typical operations, the data deduplication module traverses a volume of storage sequentially to detect repeating blocks of data. Accordingly, the stability tag for a first block of data is set and the contents are subsequently read by the data deduplication module. The data deduplication module then generates an identifier for the first block of data based on the content within the block of data. In one example, the identifier is a cryptographic hash such as SHA-256. A cryptographic hash minimizes the likelihood of collisions where differing data results in the same identifier. However, any suitable identification scheme can be utilized.

The deduplication module stores the identifier for the first block of data along with the stability tag for later reference and continues traversing the volume of storage to repeat the process of setting stability tags for blocks of data, reading content from the blocks of data, and hashing the blocks of data to generate corresponding identifiers. At a later point, the deduplication module identifies a second block of data that, when hashed, results in an identifier that matches the identifier for the first block of data. A matching identifier indicates that the content of the second block of data is identical to the content of the first block of data. As mentioned, the probability of a collision is practically minimized by utilizing a sufficiently complex identifier generation method (e.g., a hashing algorithm).

In response to detecting the matching identifier, the deduplication module refers to the stored stability tag for the first block of data. In addition, the deduplication module can be configured to refer to stability tag for the second block of data to ensure that both blocks are in a known state prior to deduplication. If the stability tags are still set, indicating the first block of data and the second block of data are in a known state, the deduplication module schedules one of the blocks of data for deduplication. Deduplicating a block of data involves deleting the content of the block of data and redirecting references for the block of data.

Alternatively, if the stability tag for the first block of data or the second block of data is cleared, indicating a modification or deletion to the associated block of data, the block of data is not scheduled for deduplication. Since the content of the first block of data and the content of the second block of data are no longer the same, neither one of the blocks of data are eligible for deduplication. Instead, the identifier and the stability tag for the second block of data is stored for later reference. In addition, the deduplication module returns to the first block of data to reanalyze the content and generate an updated identifier.

To deduplicate the second block of data, a file system identifies various entities that refer to the second block of data and redirects those references to the first block of data in preparation for deduplication. The reference counter tracks a number of entities (e.g., programs or files) currently referencing (e.g., reading or utilizing) the content of the second block of data. Consequently, while the reference counter is greater than zero indicating a reference by an entity, the second block of data cannot be deduplicated. For instance, as various applications access and read the contents of the second block of data the reference counter is accordingly incremented. As references to the second block of data are redirected from the second block of data to the first block of data (because the contents are the same), the reference counter for the second block of data is decremented by the file system and the reference counter for the first block of data is incremented.

As an illustrative example, the file system identifies four files that refer to the first block of data and seven files that refer to the second block of data. As such, the reference counter for the first block of data is four, “4”, while the reference counter for the second block of data is seven, “7”. To prepare the second block of data for deduplication, the file system redirects the references for the seven files to refer to the first block of data instead of the second block of data. Consequently, the reference counter for the first block of data is gradually incremented to eleven, “11”, while the reference counter for the second block of data is gradually decremented to zero, “0”. When the reference counter for the second block of data reaches zero, indicating no active references to the second block of data, the file system can proceed with deduplication. In various examples, the file system deletes the content of the second block of data. As such, the second block of data is now free for storing new content.

The disclosed techniques address several challenges associated with data deduplication processes. In various examples, while data deduplication is highly effective in reducing the overall size of data, the process is also computationally expensive and can result in inefficiencies that impact system performance. For instance, as mentioned above, many systems utilize a cryptographic hash for identifying blocks of data. In addition, typical deduplication processes, which lack a stability tag, must reread and rehash blocks of data when a matching identifier from a second block of data is detected. This determines whether the first block of data was modified or otherwise changed in the time between the initial hash and the detection of the matching identifier. Unfortunately, reading and hashing data tends to be the most resource intensive and time-consuming aspects of the deduplication process. Consequently, constantly performing these actions introduces significant inefficiencies to the data deduplication process. Such inefficiencies compound over time as the system analyzes thousands if not millions of blocks.

In contrast, by utilizing a stability tag to indicate the current status of a block of data with regard to whether the content of the block has been modified since last checked, the disclosed system does not need to reread and rehash every time a matching identifier is detected. If the stability tag for the first block of data is still set, the data deduplication process can safely deduplicate the second block of data. Conversely, if the stability tag is cleared, indicating a modification to the first block of data, the deduplication process then rereads and rehashes the first block of data to update the identifier. Moreover, the stability tag can be implemented as a single bit of data thereby dramatically reducing the computational cost of detecting a change at a block of data and thus improving efficiency.

In another example of the technical benefit of the present disclosure, the introduction of the stability tag enables the use of more complex methods for generating data block identifiers. As mentioned above, while collisions are unlikely when using standard existing algorithms such as SHA-256, the demands of computing systems are constantly changing as complexity and capability grow. For instance, enterprise storage devices can often exceed twenty terabytes of capacity. As such, the sheer volume of data a modern system stores and processes has increased dramatically in recent years thus increasing the likelihood of collisions. Consequently, file system architects may require increasingly complex or custom-built hashing algorithms to prevent collisions and ensure normal operations.

In still another technical benefit of the present disclosure, by enabling the use of more complex hashing algorithms through the stability tag, the techniques discussed herein improve the security of file systems. For instance, a common security exploit in cryptography is a collision attack in which an attacker attempts to find two inputs that produce the same hash value. In one scenario, the attacker utilizes hash collisions to exploit the worst-case usage of a hash table lookup. As a result, the lookup process can consume a large amount of computing resources that cause other computing operations to be delayed or to fail entirely. However, by utilizing the stability tag to minimize the frequency of rehashing, file system architects can select a suitable hashing algorithm to satisfy performance and security requirements.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of an example system for performing data deduplication using stability tags to minimize rehashing.

FIG. 2A illustrates an example system for performing data deduplication in a first phase of operation.

FIG. 2B illustrates an example system for performing data deduplication in a second phase of operation.

FIG. 2C illustrates an example system for performing data deduplication in a third phase of operation.

FIG. 3A illustrates an example system for performing data deduplication in an alternative scenario during a first phase of operation.

FIG. 3B illustrates an example for performing data deduplication in an alternative scenario during a second phase of operation.

FIG. 4 illustrates additional technical aspects of an example data deduplication module.

FIG. 5A is an example flow diagram showing aspects of a routine for utilizing a stability tag to optimize a data deduplication process.

FIG. 5B is an example flow diagram showing aspects of a routing for utilizing a reference counter to optimize a data deduplication process.

FIG. 6 is a computer architecture diagram showing an illustrative computer hardware and software architecture for a computing system capable of implementing aspects of the techniques and technologies presented herein.

FIG. 7 is a diagram illustrating an example distributed computing environment capable of implementing aspects of the techniques and technologies presented herein.

### DETAILED DESCRIPTION

The techniques described herein provide systems for enhancing the functionality of file systems by the introduction of stability tags for blocks of data to improve efficiency of data deduplication operations. The data deduplication process discussed herein is configured to applied to storage devices (e.g., solid-state devices (SSDs)) in a file system context. However, the deduplication techniques discussed herein can also be applied in a networking context to reduce the quantity of data that must be transmitted to ease network congestion. In addition, it should be understood that the data deduplication process, or module as referred to herein, can be a component and/or an extension of a file system for enabling data deduplication operations.

The disclosed system addresses several technical problems associated with data deduplication. For instance, existing approaches which lack the stability tag discussed herein frequently reread and rehash blocks of data to determine if another block of data having a matching identifier can be safely deduplicated. However, due to the computational cost of rereading and rehashing data, such an approach is highly inefficient. In contrast, by utilizing a stability tag, which may be only a single bit, the disclosed system enables deduplication processes to determine if a block of data is in a known state without expending the time and resources to reread and rehash.

In addition, by minimizing the frequency that data must be hashed, the disclosed system can enable the use of complex algorithms that are collision resistant. Collision resistance allows the system to assign every unique piece of data a correspondingly unique identifier. In this way, the disclosed system can ensure normal operations across a large volume of data. Moreover, by enabling the implementation of complex hashing algorithms, the disclosed system enhances the security of file systems by increasing resilience to common cryptographic attacks such as collision attacks and preimage attacks.

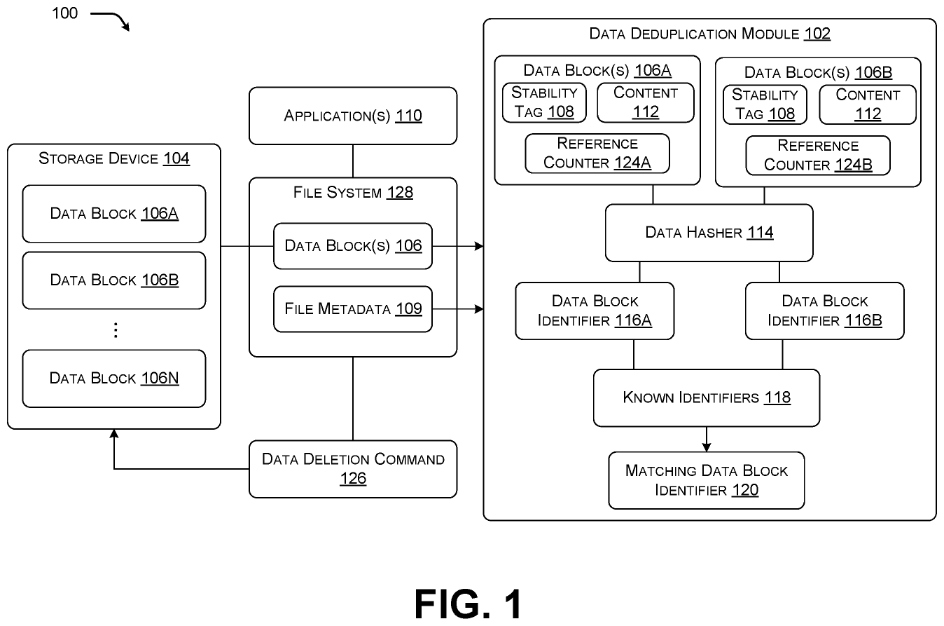

Various examples, scenarios, and aspects that enable efficient data deduplication operations are described below with respect to FIGS. 1-7.

FIG. 1 illustrates a system 100 in which a data deduplication module 102 traverses a storage device 104 to analyze data blocks 106A-106N and remove duplicate data. In various examples, the data deduplication module 102 is one or several software and/or hardware components that perform data deduplication operations. The data deduplication module 102 selects the data blocks 106 from the storage device 104 for analysis. However, prior to reading the data blocks 106, a stability tag 108 of a data block 106A is set to indicate that the data block 106A is in a known state. The stability tag 108 is stored in file metadata 109 associated with the data block 106A. Furthermore, the file metadata 109 is managed by a file system 128 which acts on the data blocks 106 on behalf of the data deduplication module 102. Moreover, the stability tag 108 can be set by the data deduplication module 102 via the file system 128. In various examples, the stability tag is a single bit that is toggled between the value zero, “0”, and the value one, “1”, to respectively indicate clear and set states. FIG. 1 further illustrates applications 110 configured to read data from and/or write data to the storage device 104. Applications 110 can be any program such as a text editor, a web browser, a video editing application, and so forth.

In various examples, the data deduplication module 102 is configured to traverse the storage device 104 sequentially, beginning with a first data block 106A. A data block 106A is any grouping of digital data such as a byte sequence. In one example, the size of the data block 106A is dictated by the hardware storage media of the storage device 104. In an alternative example, the size of the data block 106A is configured by a user such as a system administrator or engineer. When under analysis, the data block 106A is provided to a data hasher 114 which generates a corresponding data block identifier 116A based on the content 112 of the data block 106A. The data hasher 114 is a mechanism for generating data block identifiers 116. As mentioned above, the data hasher 114 is oftentimes a cryptographic hashing algorithm such as SHA-256. However, any suitable algorithm can be implemented to generate a data block identifier 116A. Moreover, the data hasher 114 can utilize any suitable method to generate the data block identifier 116A instead of, or in addition to, a cryptographic hashing algorithm. The data block identifier 116A is then stored in a set of known identifiers 118 along with the stability tag 108 for future reference. It should be understood that the storage of known identifiers 118 can be implemented using any suitable method such as a hash table, a database, and so forth.

At a later point in time, the data deduplication module 102 analyzes a second data block 106B and carries out the same process of analysis with the data hasher 114 to produce a second data block identifier 116B. When the second data block identifier 116B is provided to the known identifiers 118, a matching data block identifier 120 may be detected. In this example, the second data block identifier 116B matches the first data block identifier 116A, indicating identical content 112 between the first data block 106A and second data block 106B. In response, the data deduplication module 102 refers to the stability tag 108 for the first data block 106A to determine if the content 112 of the first data block 106A has been modified. If the stability tag 108 is set, indicating that the content of the first data block 106A has not been modified, the data deduplication module 102 proceeds to provide an indication that the second data block 106B is eligible for deduplication.

In another example, the data deduplication module 102 refers to the stability tags 108 for both the first data block 106A and the second data block 106B to determine eligibility for deduplication. This is because, in some scenarios, the content 112 of the second data block 106B may by modified or deleted after hashing by the data hasher 114 but prior to determining the matching data block identifier 120. As such, the data deduplication module 102 ensures that both stability tags 108 for both data blocks 106A and 106B are set before proceeding to deduplicate the second data block 106B.

To deduplicate the second block of data 106B, file system 128 analyzes a first reference counter 124A for the first data block 106A and a second reference counter 124B for the second data block 106B. The reference counter 124A is an indicator of the number of entities that refer to a particular data block 106A such as the applications 110. While a reference counter 124A is greater than zero, it is understood by the system 100 that the associated data block 106A is currently in use and thus cannot be overwritten, modified, or otherwise changed. As with the stability tag 108 discussed above, the reference counters 124 for the data blocks 106 are stored within the file metadata 109 and managed by the file system 128.

As will be elaborated upon below, the file system 128 redirects references to the second data block 106B to the first data block 106A to deduplicate the second data block 106B. Accordingly, the second reference counter 124B for the second data block 106B is decremented while the first reference counter 124A for the first data block 106A is incremented. In various examples, reference counters 124 are incremented by the file system 128 in response to accesses to the data blocks 106 by various applications 110 or other entities that interact with data blocks 106. As references to the second data block 106B are redirected by the file system 128, the second reference counter 124B for the second data block 106B decrements to zero while the first reference counter 124A increments. When the second reference counter 124B reaches zero, a data deletion command 126 is generated and executed by the file system 128. Accordingly, the content 112 of the data block 106B is deleted and the storage space associated with the second data block 106B is freed. In this way, the total occupied volume of storage within the storage device 104 is reduced thereby improving the overall utilization of the storage device 104.

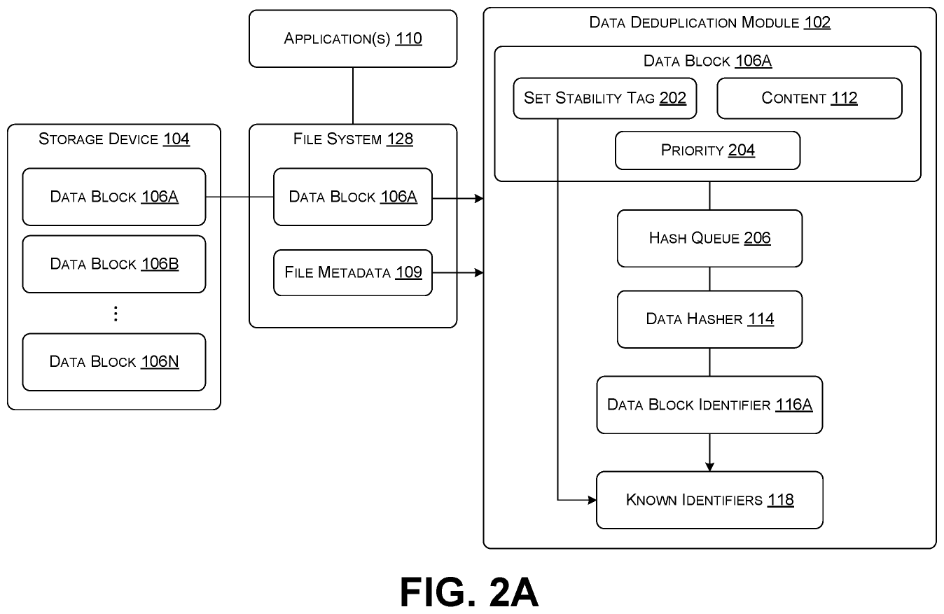

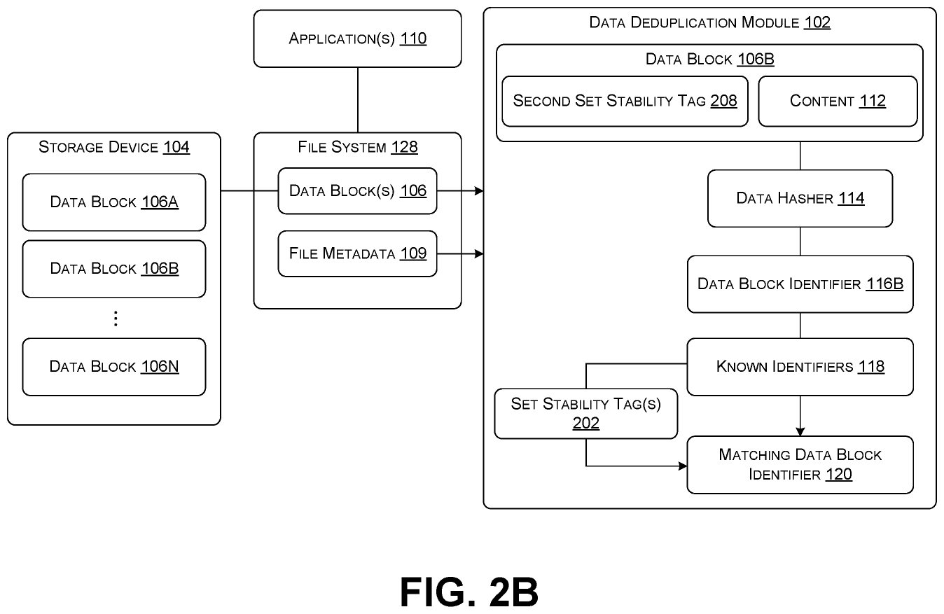

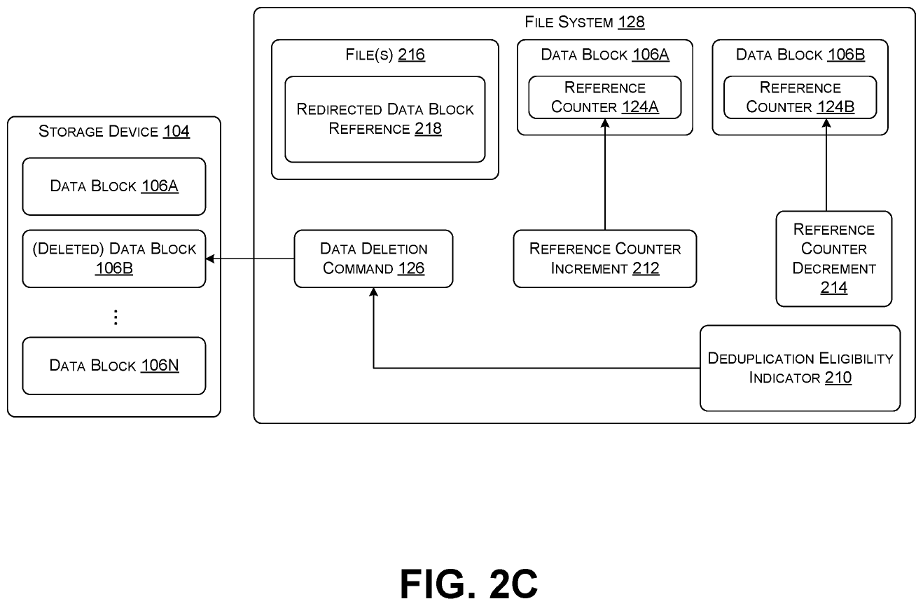

Turning now to FIG. 2A, additional aspects of the system 100 are shown and described. As discussed above, prior to reading the content 112 of the first data block 106A, a set stability tag 202 included in the data block 106A which is generated by the data deduplication module 102 prior to analysis by the data hasher 114. As mentioned, the set stability tag 202 indicates that the content 112 of the data block 106A is in a known state. Stated another way, the set stability tag 202 informs the data deduplication module 102 that the data block 106A has not been modified since it was last analyzed by the deduplication module 102.

In various examples, the data block 106A also includes a priority 204 which dictates placement of the data block 106A in a hash queue 206. The priority 204 defines an importance of the associated data block 106A relative to other data blocks 106B. In various examples, the priority 204 is a numerical score. However, any suitable format can be utilized to express the relative importance of the data blocks 106 for deduplication purposes. While the data deduplication module 102 may typically extract and process data blocks 106 in sequential order, the system 100 can alternatively be configured to dynamically process data blocks 106 based on the priority 204. In one example, the priority 204 for a data block 106A is assigned based on the application 110 which originated the content 112. For instance, data from a security application can be assigned a higher priority 204 in comparison to a text editor. In addition, while the priority 204 can be expressed as a numerical score for each data block 106, any suitable format can be utilized.

In another example, data blocks 106 originating from the same application 110 are assigned a high priority as data from the same application 110 may be more likely to match, and thus, be eligible for deduplication. For example, the data deduplication module 102 detects that the first data block 106A originates from a text editing application 110 while the second data block 106B originates from a web browser. Accordingly, both the first data block 106A and the second data block 106B are assigned a default priority 204. However, the data deduplication module 102 may detect that a third data block 106N originates from the same text editing application 110 as the first data block 106A. In response, the priority 204 for the second data block 106B is decreased while the priority 204 for the third data block 106N is increased. Consequently, the third data block 106N is placed ahead of the second data block 106B in the hash queue 206. As described above, the data hasher 114 then processes the data block 106A and the resulting data block identifier 116A is stored in the known identifiers 118 along with the set stability tag 202 for reference.

Proceeding now to FIG. 2B, the data deduplication module 102 processes a second data block 106B. In one example, the data deduplication module 102 sequentially reads and processes data blocks 106 from the storage device 104. Alternatively, the data deduplication module 102 can be configured to extract a plurality of data blocks 106 to fill a hash queue 206 as discussed above with respect to FIG. 2A. However, the former scenario is illustrated in FIG. 2B where the data deduplication module 102 extracts and processes a first data block 106A then proceeds to extract a second data block 106B.

As with the first data block 106A, the second data block 106B includes a second set stability tag 208 as well as the corresponding content 112. When processing the second data block 106B, the data hasher 114 generates a data block identifier 116B which is accordingly provided to the set of known identifiers 118 for comparison against previous entries. In this example, the data block identifier 116B for the second data block 106B matches the data block identifier 116A for the first data block 106A. Accordingly, the comparison against the known identifiers 118 results in a matching data block identifier 120.

In response to the matching data block identifier 120, the data deduplication module 102 returns to the known identifiers 118 to extract the set stability tag 202 for the first data block 106A. In this example, the content 112 of the first data block 106A has not been modified in the intervening period between processing the first data block 106A and the second data block 106B hence the set stability tag 202. In addition, the data deduplication module 102 also refers to the second set stability tag 208 to ensure that the content 112 of the second data block 106B has not been modified. As mentioned above, the content 112 of the second data block 106B can be modified or deleted in the time between generating the data block identifier 116B and determining the matching data block identifier 120. Accordingly, the second set stability tag 208 is cleared in response to modifications or deletions of the content 112 rendering the second data block 106B ineligible for deduplication. However, in the example shown in FIG. 2B, the second data block 106B has not been modified, hence the second set stability tag 208. Consequently, the data deduplication module 102 determines that the second data block 106B is eligible for deduplication in response to checking the set stability tag 202 and the second set stability tag 208.

Turning to FIG. 2C, a deduplication eligibility indicator 210 for the second block of data 106B is received at the file system 128. In one example, the deduplication eligibility indicator 210 is the stability tag 108 for the first data block 106A. In this way, the deduplication eligibility indicator 210 enables the file system 128 to verify the validity of the deduplication operation prior to deleting the content 112 of the second data block 106B. To begin deduplicating the second data block 106B, the file system 128 generates a reference counter increment 212 which is applied to the reference counter 124A for the first data block 106A. In addition, the file system 128 generates a reference counter decrement 214 which is applied to the reference counter 124B for the second data block 106B. As discussed above, a reference counter 124B indicates a number of entities that refer to the associated data block 106B. To deduplicate the second data block 106B, the file system 128 redirects references to the second data block 106B so they instead refer to the first data block 106A which contains the same content 112. For example, as shown in FIG. 2C, a file 216 that contains a reference to the second data block 106B is identified and the reference is redirected to the first data block 106A, and thus, the file 216 includes a redirected data block reference 218.

In various examples, the file system 128 searches for and reformats all files 216 that refer to the second data block 106B with the redirected data block reference 218. For each file 216 that receives a redirected data block reference 218, a reference counter increment 212 and reference counter decrement 214 are generated and applied to the reference counters 124A and 124B respectively. The increment and decrement operations are repeated by the file system 128 until the reference counter 124B for the second data block 106B equals zero. This indicates that there are no longer any files 216 that refer to the second data block 106B. As such, the second data block 106B is now ready for deduplication by the file system 128.

In an illustrative example, there are five files 216 that refer to the first data block 106A and four files 216 that refer to the second data block 106B. Accordingly, the first reference counter 124A is five, “5”, while the second reference counter 124B is four, “4”. After executing the increment and decrement cycle discussed above, the first reference counter 124A becomes nine, “9”, while the second reference counter 124B becomes zero, “0”. When the second reference counter 124B for the second data block 106B reaches zero, the deduplication eligibility indicator 210 can be transformed by the file system 128 into a data deletion command 126. For instance, at a later point in time, subject to computing resource availability, program parallelism and/or other factors, the file system 128 generates the data deletion command 126 which is executed by the storage device 104. In response, the second data block 106B is deleted from the storage device 104. Accordingly, the storage space previously occupied by the second data block 106B is now free for use.

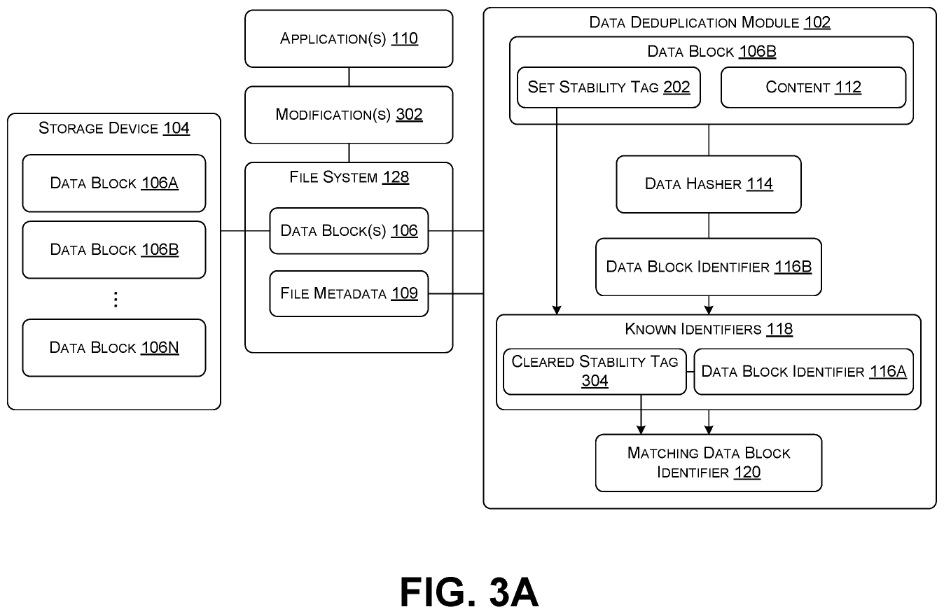

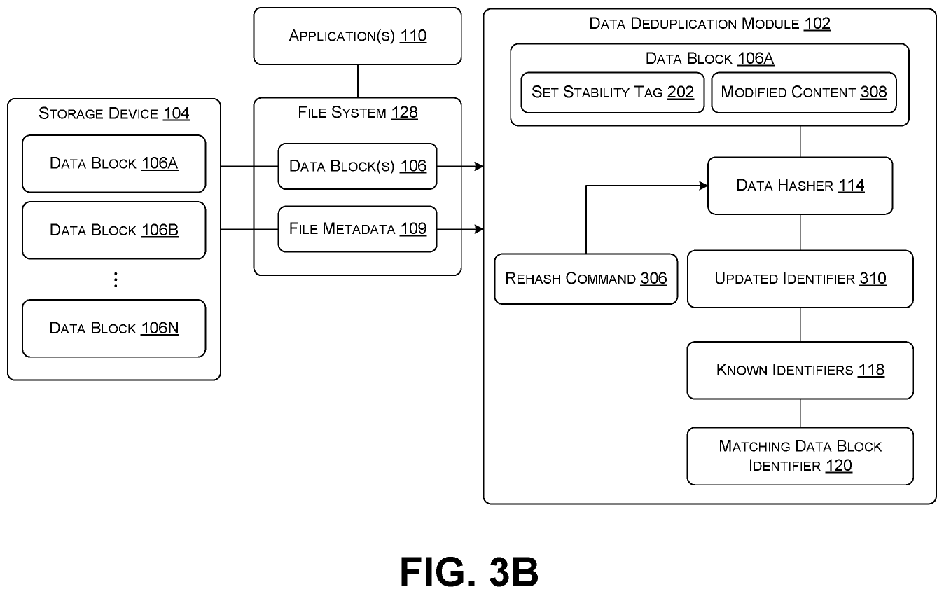

Turning now to FIG. 3A, an alternative scenario in which a modification 302 results in a cleared stability tag 304 is shown and described. The modification 302 is any change to the content 112 of the data block 106A such as an overwrite. As discussed above, the stability tag 108 indicates whether an associated data block 106 is currently in a known state. For example, the set stability tag 202 in the above example indicates that the data block 106A has not been modified since being processed by the data hasher 114 to generate the data block identifier 116A. Conversely, if a data block 106A receives a modification 302 from an application 110, the set stability tag 202 is cleared. While the example shown in FIG. 3A involves a cleared stability tag 304 for the first data block 106A, it should be understood that the second data block 106B may also have a cleared stability tag 304 following modification or deletion of its content 112. As such, the data deduplication module 102 can be configured to check both the first data block 106A and the second data block 106B for cleared stability tags 304.

In the example of FIG. 3A, the data deduplication module 102 has completed processing a first data block 106A and stored the resultant data block identifier 116A in the known identifiers 118. However, while the data deduplication module 102 is processing a second data block 106B, a modification 302 is applied to the first data block 106A. In response, the stability tag 108 for the first data block 106A is cleared 304 indicating that the first data block 106A is no longer in a known state. Subsequently, when a second data block 106B is processed by the data hasher 114 to generate a second data block identifier 116B, a matching data block identifier 120 is still generated as the first data block identifier 116A has not been modified, even though the underlying content has been modified.

In response to the matching data block identifier 120, the data deduplication module 102 returns to the known identifiers 118 to refer to the stability tag 108 associated with the first data block 106A. In this example, the stability tag 108 is a cleared stability tag 304 due to the modification 302. Accordingly, the data deduplication module 102 determines that the second data block 106B is not eligible for deduplication despite the matching data block identifier 120. Moreover, since the second data block 106B does not have another match within the known identifiers 118, the data deduplication module 102 determines that the second data block 106B is unique. Consequently, the second data block identifier 116B and associated stability tag 108 are stored in the known identifiers 118.

Turning now to FIG. 3B, in response to detecting the cleared stability tag 304 discussed above, the data deduplication module 102 generates a rehash command 306 to reanalyze the first data block 106A using the data hasher 114. The rehash command 306 directs the data hasher 114 to analyze the content 112 of the data block 106A. Since the data block 106A now contains modified content 308, rehashing the data block 106A will result in an updated identifier 310 that is different from the original data block identifier 116A associated with the data block 106A. Accordingly, the updated identifier 310 is stored in the known identifiers 118. Furthermore, a new set stability tag 202 is also stored in association with the first data block 106A as the data block 106A has now been reanalyzed and exists in a known state.

In addition, when the updated identifier 310 is provided to the known identifiers 118, the data deduplication module 102 may detect a matching data block identifier 120. In various examples, this is due to the modification 302 having been applied to several data blocks 106. In response, the data deduplication module 102 can proceed to carry out the deduplication process described above by checking the stability tags 108 for matching data blocks 106 and issuing data deletion commands 126 as necessary.

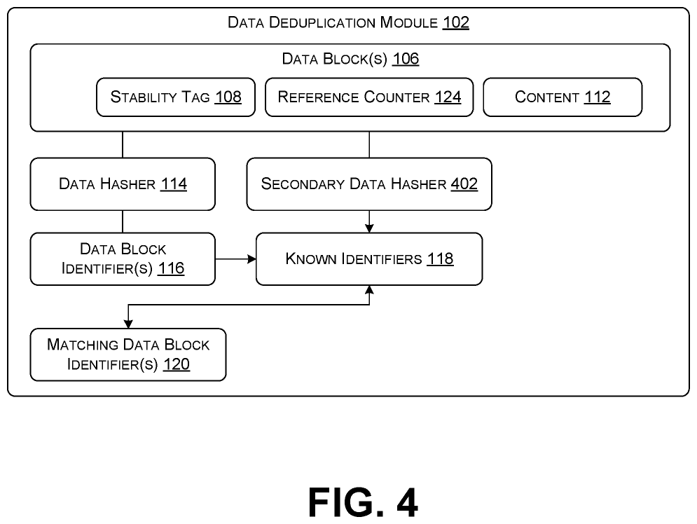

Proceeding to FIG. 4, additional aspects of the data deduplication module 102 are shown and described. As discussed above, the data deduplication module 102 analyzes a plurality of data blocks 106 using a data hasher 114 to generate data block identifiers 116 based on the content 112 of the data blocks 106. As discussed above, the data deduplication module 102 can also include a hash queue 206 for staging multiple data blocks 106 for analysis by the data hasher 114. In another example, the data deduplication module 102 includes a secondary data hasher 402 for parallel processing of data blocks 106. Stated another way, the data deduplication 102 can be configured to simultaneously generate data block identifiers 116 for multiple data blocks 106. For instance, while the data hasher 114 is occupied with a first data block 106A, the data deduplication module 102 directs a second data block 106B to the secondary data hasher 402. In this example, both the data hasher 114 and the secondary data hasher 402 utilize the same method for generating data block identifiers 116 (e.g., the same hashing algorithm) to maintain consistency.

In an alternative scenario, the data hasher 114 and the secondary data hasher 402 are configured to serve different sets of data blocks 106. For example, the data deduplication module 102 may be configured to process data blocks 106 from two different storage devices 104 (e.g., a server receiving data from two different devices). Since the data deduplication module 102 is processing two different volumes of data, applying a stability tag 108 to a data block 106 from one set to deduplicate a data block 106 from another naturally causes operational issues. Thus, data blocks 106 from the first storage device is directed to the data hasher 114 while data blocks 106 from a second storage device are directed to the secondary data hasher 402. Accordingly, the storage for known identifiers 118 is partitioned to separate data block identifiers 116 and stability tags 108 from the first set of data blocks 106 and the second set of data blocks 106. In this example, the data hasher 114 and the secondary data hasher 402 utilize different methods for generating data block identifiers 116 (e.g., different hashing algorithms). However, both the data hasher 114 and the secondary data hasher 402 may still utilize the same method.

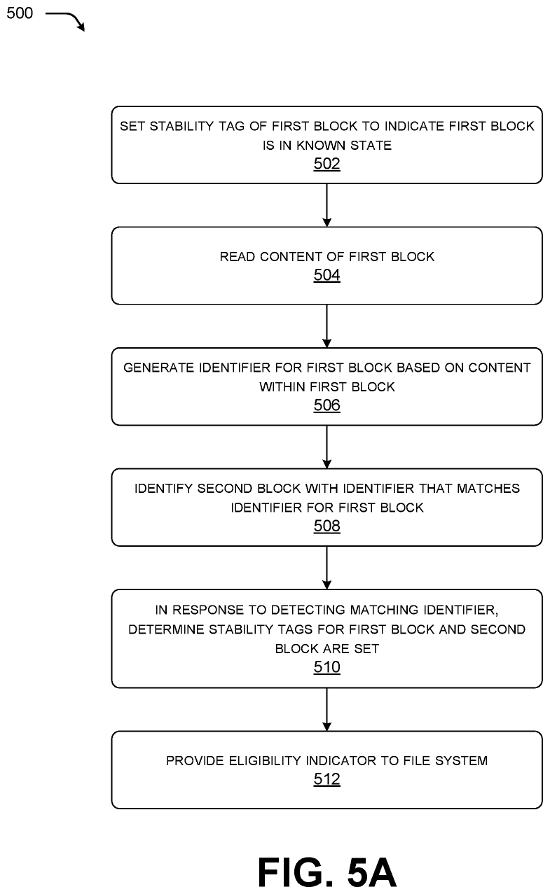

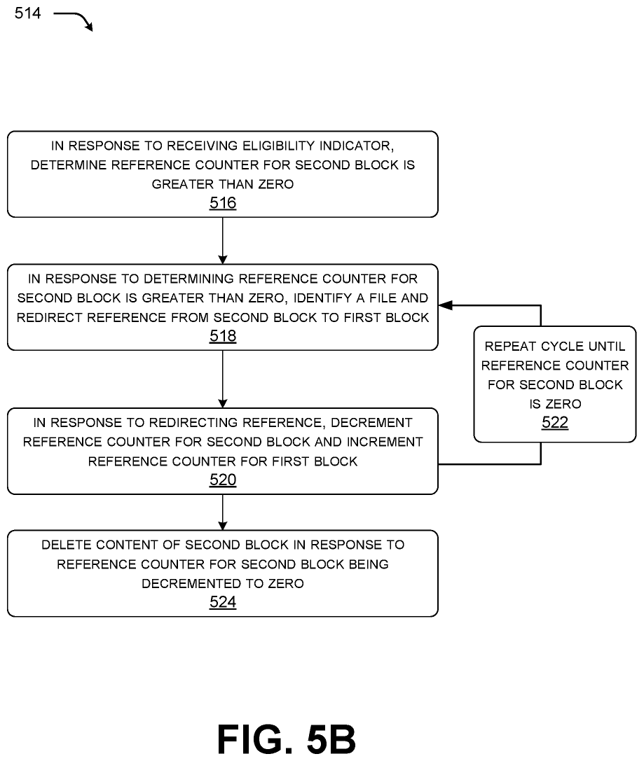

Turning now to FIG. 5A, aspects of a routine 500 for enabling efficient data deduplication using stability tags are shown and described. In various examples, the operations of the routine 500 shown in FIG. 5A are performed by the data deduplication module 102 after data blocks are accessed and/or retrieved, as discussed above. With reference to FIG. 5A, the routine 500 beings at operation 502 where a system sets a stability tag for a first block of data to indicate that the first block of data is in a known state.

Next, at operation 504, the content of the first block of data is read by the system.

Then, at operation 506, the system generates an identifier for the first block of data based on the content of the first block of data.

Subsequently, at operation 508, the system identifies a second block of data having an identifier that matches the identifier for the first block of data indicating that the content of the second block of data is identical to the content of the first block of data. For instance, the content of the second block of data is read and the identifier for the second block of data is generated after operations 504 and 506.

Next, at operation 510, in response to identifying the second block of data with the matching identifier, the system refers to the stability tag of the first block of data and the stability tag of the second block of data to determine that the stability tags for both blocks are set.

Then, at operation 512, in response to detecting that the stability tag is still set, the system provides an eligibility indicator to a file system to indicate that the second block of data is eligible for deduplication.

Turning now to FIG. 5B, aspects of the routine 514 are shown and described. While the operations shown in FIG. 5A are performed by the data deduplication module 102, the operations of FIG. 5B are performed by the file system 128 after the file system receives an eligibility indicator from the deduplication module. With reference to FIG. 5B, the routine 514 begins at operation 516, where in response to receiving the eligibility indicator, the file system determines that a reference counter for the second block of data is greater than zero.

Next, at operation 518, in response to determining the reference counter for the second block of data is greater than zero, the file system identifies a file having a reference to the second block of data and redirects the reference from the second block of data to the first block of data.

Proceeding to operation 520, in response to redirecting the reference from the second block of data to the first block of data, the system decrements a reference counter for the second block of data and increments a reference counter for the first block of data.

As illustrated by 522, the file system repeats the cycle captured by operations 518 and 520 until the reference counter for the second block of data is decremented to zero.

Finally, at operation 5124 the content of the second block of data is deleted in response to the reference counter for the second block of data being decremented to zero.

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 500 can be implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the illustration may refer to the components of the figures, it should be appreciated that the operations of the routine 500 may be also implemented in other ways. In one example, the routine 500 is implemented, at least in part, by a processor of another remote computer or a local circuit. In addition, one or more of the operations of the routine 500 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

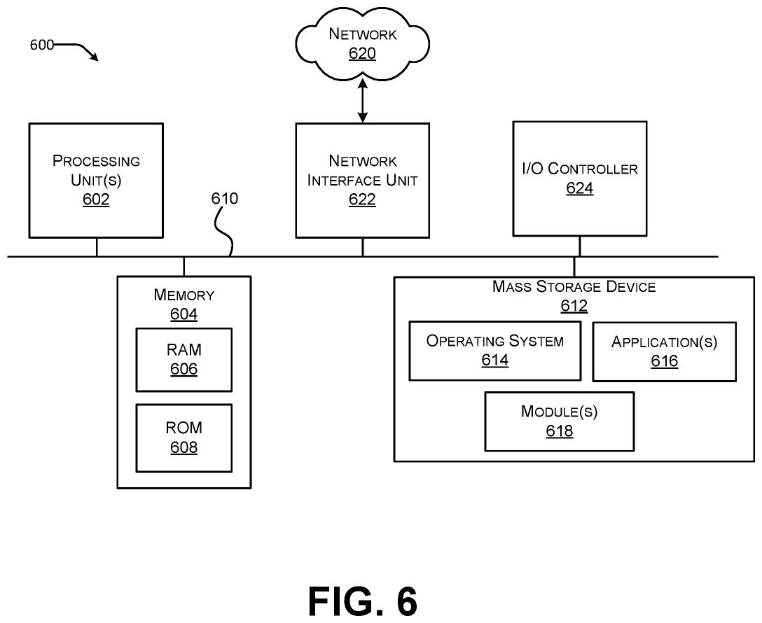

FIG. 6 shows additional details of an example computer architecture 600 for a device, such as a computer or a server configured as part of the cloud-based platform or system 100, capable of executing computer instructions (e.g., a module or a program component described herein). The computer architecture 600 illustrated in FIG. 6 includes processing unit(s) 602, a system memory 604, including a random-access memory 606 (RAM) and a read-only memory (ROM) 608, and a system bus 610 that couples the memory 604 to the processing unit(s) 602. The processing units 602 may also comprise or be part of a processing system. In various examples, the processing units 602 of the processing system are distributed. Stated another way, one processing unit 602 of the processing system may be located in a first location (e.g., a rack within a datacenter) while another processing unit 602 of the processing system is located in a second location separate from the first location.

Processing unit(s), such as processing unit(s) 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing unit(s) 602 through a mass storage controller connected to the bus 610. The mass storage device 612 and its associated computer-readable media provide non-volatile storage for the computer architecture 600. Although the description of computer-readable media contained herein refers to a mass storage device, it should be appreciated by those skilled in the art that computer-readable media can be any available computer-readable storage media or communication media that can be accessed by the computer architecture 600.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

It should be appreciated that the software components described herein may, when loaded into the processing unit(s) 602 and executed, transform the processing unit(s) 602 and the overall computer architecture 600 from a general-purpose computing system into a special-purpose computing system customized to facilitate the functionality presented herein. The processing unit(s) 602 may be constructed from any number of transistors or other discrete circuit elements, which may individually or collectively assume any number of states. More specifically, the processing unit(s) 602 may operate as a finite-state machine, in response to executable instructions contained within the software modules disclosed herein. These computer-executable instructions may transform the processing unit(s) 602 by specifying how the processing unit(s) 602 transition between states, thereby transforming the transistors or other discrete hardware elements constituting the processing unit(s) 602.

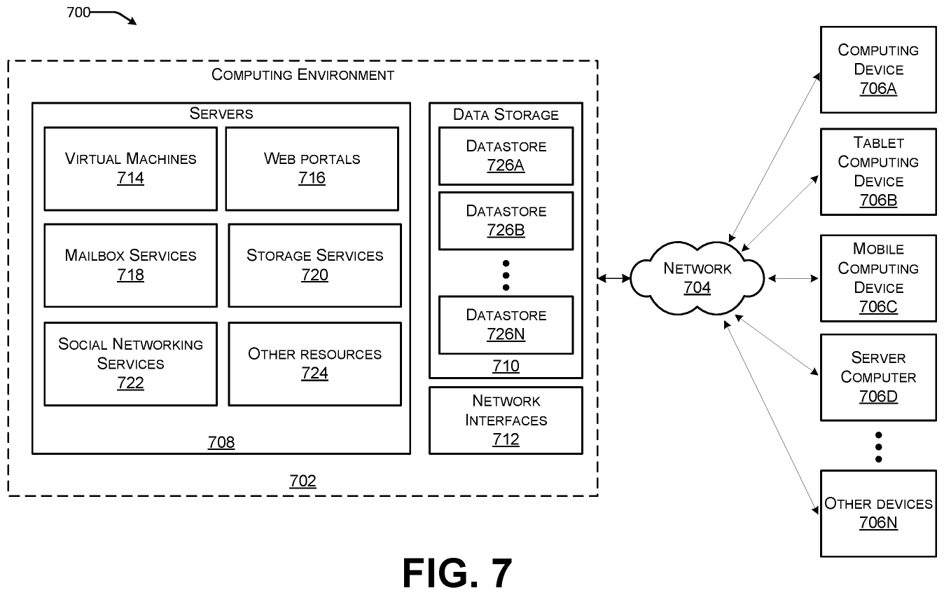

FIG. 7 depicts an illustrative distributed computing environment 700 capable of executing the software components described herein. Thus, the distributed computing environment 700 illustrated in FIG. 7 can be utilized to execute any aspects of the software components presented herein. For example, the distributed computing environment 700 can be utilized to execute aspects of the software components described herein.

Accordingly, the distributed computing environment 700 can include a computing environment 702 operating on, in communication with, or as part of the network 704. The network 704 can include various access networks. One or more client devices 706A-706N (hereinafter referred to collectively and/or generically as “computing devices 706”) can communicate with the computing environment 702 via the network 704. In one illustrated configuration, the computing devices 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of computing devices 706 can communicate with the computing environment 702.

In various examples, the computing environment 702 includes servers 708, data storage 610, and one or more network interfaces 712. The servers 708 can host various services, virtual machines, portals, and/or other resources. In the illustrated configuration, the servers 708 host virtual machines 714, Web portals 716, mailbox services 718, storage services 720, and/or social networking services 722. As shown in FIG. 7 the servers 708 also can host other services, applications, portals, and/or other resources (“other resources”) 724.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more servers configured to host data for the computing environment 700. The data storage 710 can include, host, or provide one or more real or virtual datastores 726A-726N (hereinafter referred to collectively and/or generically as “datastores 726”). The datastores 726 are configured to host data used or created by the servers 808 and/or other data. That is, the datastores 726 also can host or store web page documents, word documents, presentation documents, data structures, algorithms for execution by a recommendation engine, and/or other data utilized by any application program. Aspects of the datastores 726 may be associated with a service for storing files.

The computing environment 702 can communicate with, or be accessed by, the network interfaces 712. The network interfaces 712 can include various types of network hardware and software for supporting communications between two or more computing devices including the computing devices and the servers. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the computing devices. It should be understood that the computing devices can include real or virtual machines including server computers, web servers, personal computers, mobile computing devices, smart phones, and/or other devices. As such, various configurations of the concepts and technologies disclosed herein enable any device configured to access the distributed computing environment 700 to utilize the functionality described herein for providing the techniques disclosed herein, among other aspects.

The disclosure presented herein also encompasses the subject matter set forth in the following clauses.

Example Clause A, a method for data deduplication comprising: setting, using a processing system, a stability tag for a first block of data to indicate that the first block of data, the first block of data having a first reference counter; reading content from the first block of data; generating a first identifier for the first block of data based on the content of the first block of data; identifying a second block of data that has a second identifier that is a match for the first identifier, the match indicating that content of the second block of data is identical to the content of the first block of data; in response to identifying the second block of data, determining that the stability tag for the first block of data is set and that a stability tag for the second block of data is set; in response to determining that the stability tag for the first block of data is set and that a stability tag for the second block of data is set, determining that a second reference counter for the second block of data is greater than zero; in response to determining that the second reference counter for the second block of data is greater than zero, redirecting a data block reference for each file from the second block of data to the first block of data; in response to redirecting the data block reference for each file from the second block of data to the first block of data, decrementing the second reference counter and incrementing the first reference counter for each file, until the second reference counter is decremented to zero; and deleting the content of the second block of data in response to the second reference counter being decremented to zero.

Example Clause B, the method of Example Clause A, wherein the stability tag for the first block of data is cleared by a file system containing the first block of data following deletion of the content of the first block of data by the file system.

Example Clause C, the method of Example Clause A or Example Clause B, wherein deleting the content of the second block of data comprises: generating a deduplication eligibility indicator using a data deduplication module; providing the deduplication eligibility indicator to a file system containing the second block of data; and executing a data deletion command using the file system to free a storage space associated with the second block of data.

Example Clause D, the method of any one of Example Clause A through C, wherein a file system identifies a plurality of files that references the second block of data.

Example Clause E, the method of any one of Example Clause A through C, wherein the stability tag for the first block of data is cleared in response to detecting a modification of the content of the first block of data.

Example Clause F, the method of Example Clause E, further comprising, in response to the stability tag of the first block of data being cleared, generating a new identifier for the first block of data based on the modified content of the first block of data.

Example Clause G, a system comprising: a processing system; and a computer-readable medium having encoded thereon computer-readable instructions that when executed by the processing system cause the system to: identify a match between a first identifier for a first block of data and a second identifier for a second block of data, the match indicating that content of the first block of data is identical to content of the second block of data; determine, based at least in part on the match, that a first stability tag for the first block of data is set; determine, based at least in part on the match, that a second stability tag for the second block of data is set; and in response to determining that both the first stability tag and the second stability tag are set, provide an indicator that the second block of data is eligible for deduplication to a file system.

Example Clause H, the system of Example Clause G, wherein the first stability tag of the first block of data is cleared by the file system containing the first block of data.

Example Clause I, the system of Example Clause G or Example H, wherein the computer-readable instructions further cause the system to: determine that a reference counter for the second block of data is greater than zero; in response to determining that the reference counter for the second block of data is greater than zero, redirect a data block reference for each file of a plurality of files from the second block of data to the first block of data; in response to redirecting the data block reference for each file of the plurality of files from the second block of data to the first block of data, decrement the reference counter for the second block of data and increment a reference counter for the first block of data, until the reference counter for the second block of data is decremented to zero; and delete the content of the second block of data in response to the reference counter for the second block of data being decremented to zero, the deletion of the content freeing up a storage space associated with the second block of data for storing new content.

Example Clause J, the system of Example Clause I, wherein the file system identifies the plurality of files that references the second block of data.

Example Clause K, the system of Example Clause I, wherein deletion of the content of the second block of data is prevented as long as the reference counter for the second block of data is greater than zero.

Example Clause L, the system of any one of Example Clause G, wherein the first stability tag of the first block of data is cleared in response to detecting a modification of the content of the first block of data.

Example Clause M, the system of Example Clause L, wherein the computer-readable instructions further cause the system to, in response to the first stability tag of the first block of data being cleared, generate a new identifier for the first block of data based on the modified content of the first block of data.

Example Clause N, a computer-readable storage medium having encoded thereon computer-readable instructions that when executed by a processing system cause a system to: identify a match between a first identifier for a first block of data and a second identifier for a second block of data, the match indicating that content of the first block of data is identical to content of the second block of data; determine, based at least in part on the match, that a first stability tag for the first block of data is set; determine, based at least in part on the match, that a second stability tag for the second block of data is set; and in response to determining that both the first stability tag and the second stability tag are set, provide an indicator that the second block of data is eligible for deduplication to a file system.

Example Clause O, the computer-readable storage medium of Example Clause N, wherein the first stability tag of the first block of data is cleared by the file system containing the first block of data.

Example Clause P, the computer-readable storage medium of Example Clause N or Example Clause O, wherein the computer-readable instructions further cause the system to: determine that a reference counter for the second block of data is greater than zero; in response to determining that the reference counter for the second block of data is greater than zero, redirect a data block reference for each file of a plurality of files from the second block of data to the first block of data; in response to redirecting the data block reference for each file of the plurality of files from the second block of data to the first block of data, decrement the reference counter for the second block of data and increment a reference counter for the first block of data, until the reference counter for the second block of data is decremented to zero; and delete the content of the second block of data in response to the reference counter for the second block of data being decremented to zero, the deletion of the content freeing up a storage space associated with the second block of data for storing new content.

Example Clause Q, the computer-readable storage medium of Example Clause P, wherein the file system identifies the plurality of files that references the second block of data.

Example Clause R, the computer-readable storage medium of Example Clause P, wherein deletion of the content of the second block of data is prevented as long as the reference counter for the second block of data is greater than zero.

Example Clause S, the computer-readable storage medium of any one of Example Clause N, wherein the first stability tag of the first block of data is cleared in response to detecting a modification of the content of the first block of data.

Example Clause T, the computer-readable storage medium of Example Clause S, wherein the computer-readable instructions further cause the system to, in response to the first stability tag of the first block of data being cleared, generate a new identifier for the first block of data based on the modified content of the first block of data.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different data blocks).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for data deduplication comprising:
setting, using a processing system, a stability tag for a first block of data to indicate that the first block of data, the first block of data having a first reference counter;
reading content from the first block of data;
generating a first identifier for the first block of data based on the content of the first block of data;
identifying a second block of data that has a second identifier that is a match for the first identifier, the match indicating that content of the second block of data is identical to the content of the first block of data;
in response to identifying the second block of data, determining that the stability tag for the first block of data is set and that a stability tag for the second block of data is set;
in response to determining that the stability tag for the first block of data is set and that a stability tag for the second block of data is set, determining that a second reference counter for the second block of data is greater than zero;
in response to determining that the second reference counter for the second block of data is greater than zero, redirecting a data block reference for each file from the second block of data to the first block of data;
in response to redirecting the data block reference for each file from the second block of data to the first block of data, decrementing the second reference counter and incrementing the first reference counter for each file, until the second reference counter is decremented to zero; and
deleting the content of the second block of data in response to the second reference counter being decremented to zero.

2. The method of claim 1, wherein the stability tag for the first block of data is cleared by a file system containing the first block of data following deletion of the content of the first block of data by the file system.

3. The method of claim 1, wherein deleting the content of the second block of data comprises:
generating a deduplication eligibility indicator using a data deduplication module;
providing the deduplication eligibility indicator to a file system containing the second block of data; and
executing a data deletion command using the file system to free a storage space associated with the second block of data.

4. The method of claim 1, wherein a file system identifies a plurality of files that references the second block of data.

5. The method of claim 1, wherein the stability tag for the first block of data is cleared in response to detecting a modification of the content of the first block of data.

6. The method of claim 5, further comprising, in response to the stability tag of the first block of data being cleared, generating a new identifier for the first block of data based on the modified content of the first block of data.

7. A system comprising:
a processing system; and
a computer-readable medium having encoded thereon computer-readable instructions that when executed by the processing system cause the system to:
identify a match between a first identifier for a first block of data and a second identifier for a second block of data, the match indicating that content of the first block of data is identical to content of the second block of data;
determine, based at least in part on the match, that a first stability tag for the first block of data is set;
determine, based at least in part on the match, that a second stability tag for the second block of data is set; and
in response to determining that both the first stability tag and the second stability tag are set, provide an indicator that the second block of data is eligible for deduplication to a file system.

8. The system of claim 7, wherein the first stability tag of the first block of data is cleared by the file system containing the first block of data.

9. The system of claim 7, wherein the computer-readable instructions further cause the system to:
determine that a reference counter for the second block of data is greater than zero;
in response to determining that the reference counter for the second block of data is greater than zero, redirect a data block reference for each file of a plurality of files from the second block of data to the first block of data;
in response to redirecting the data block reference for each file of the plurality of files from the second block of data to the first block of data, decrement the reference counter for the second block of data and increment a reference counter for the first block of data, until the reference counter for the second block of data is decremented to zero; and
delete the content of the second block of data in response to the reference counter for the second block of data being decremented to zero, the deletion of the content freeing up a storage space associated with the second block of data for storing new content.

10. The system of claim 9, wherein the file system identifies the plurality of files that references the second block of data.

11. The system of claim 9, wherein deletion of the content of the second block of data is prevented as long as the reference counter for the second block of data is greater than zero.

12. The system of claim 7, wherein the first stability tag of the first block of data is cleared in response to detecting a modification of the content of the first block of data.

13. The system of claim 12, wherein the computer-readable instructions further cause the system to, in response to the first stability tag of the first block of data being cleared, generate a new identifier for the first block of data based on the modified content of the first block of data.

14. A computer-readable storage medium having encoded thereon computer-readable instructions that when executed by a processing system cause a system to:
identify a match between a first identifier for a first block of data and a second identifier for a second block of data, the match indicating that content of the first block of data is identical to content of the second block of data;
determine, based at least in part on the match, that a first stability tag for the first block of data is set;
determine, based at least in part on the match, that a second stability tag for the second block of data is set; and
in response to determining that both the first stability tag and the second stability tag are set, provide an indicator that the second block of data is eligible for deduplication to a file system.

15. The computer-readable storage medium of claim 14, wherein the first stability tag of the first block of data is cleared by the file system containing the first block of data.

16. The computer-readable storage medium of claim 14, wherein the computer-readable instructions further cause the system to:
determine that a reference counter for the second block of data is greater than zero;
in response to determining that the reference counter for the second block of data is greater than zero, redirect a data block reference for each file of a plurality of files from the second block of data to the first block of data;
in response to redirecting the data block reference for each file of the plurality of files from the second block of data to the first block of data, decrement the reference counter for the second block of data and increment a reference counter for the first block of data, until the reference counter for the second block of data is decremented to zero; and
delete the content of the second block of data in response to the reference counter for the second block of data being decremented to zero, the deletion of the content freeing up a storage space associated with the second block of data for storing new content.

17. The computer-readable storage medium of claim 16, wherein the file system identifies the plurality of files that references the second block of data.

18. The computer-readable storage medium of claim 16, wherein deletion of the content of the second block of data is prevented as long as the reference counter for the second block of data is greater than zero.

19. The computer-readable storage medium of claim 14, wherein the first stability tag of the first block of data is cleared in response to detecting a modification of the content of the first block of data.

20. The computer-readable storage medium of claim 19, wherein the computer-readable instructions further cause the system to, in response to the first stability tag of the first block of data being cleared, generate a new identifier for the first block of data based on the modified content of the first block of data.
